(19) United States
(12) Patent Application Publication
(10) Pub. No.: US 2023/0134989 A1
(43) Pub. Date: May 4, 2023

(54) SYSTEM AND METHOD FOR BUILDING DOCUMENT RELATIONSHIPS AND AGGREGATES

(71) Applicant: ThoughtTrace, Inc., Magnolia, TX (US)

(72) Inventors: Joel M. HRON, II, The Woodlands, TX (US); Nicholas E. VANDIVERE, Spring, TX (US); Daniel DROKE, Magnolia, TX (US)

(21) Appl. No.: 17/980,360

(22) Filed: Nov. 3, 2022

Related U.S. Application Data
(60) Provisional application No. 63/275,801, filed on Nov. 4, 2021.

(51) Int. Cl. G06N 20/00; G06F 16/93

(52) U.S. Cl. CPC G06N 20/00; G06F 16/93

(57) ABSTRACT

Aspects of the present disclosure involve systems and methods for automated analysis of documents to obtain attributes associated with those documents, and using the attributes to organize, relate, and/or aggregate documents. Attributes can be applied to the document or inferred from the document based on a machine learning model. One or more of either of these types of attributes can be used to relate documents together, join them together, or aggregate them with their associated metadata into a composite result. The aggregation of attributes may include rules for how attributes are to be aggregated. In one implementation, a document management system may receive a collection of documents and scan the documents to create a corresponding image for use in aggregating the documents. An artificial intelligence or machine learning technique may then be applied to the collection of documents to extract or otherwise determine attributes or data from the documents.

### CROSS-REFERENCE TO RELATED APPLICATION

This application is related to and claims priority under 35 U.S.C. § 119(e) from U.S. Pat. Application No. 63/275,801 filed Nov. 4, 2021, entitled “System and Method for Building Document Relationships and Aggregates”, the entire contents of which is incorporated herein by reference for all purposes.

### FIELD

The present disclosure relates to processing of documents, and in particular, to aggregating documents based on relationships of attributes associated with the documents and/or correcting determined inconsistencies between aggregated documents.

### BACKGROUND

In nearly any relatively large organization, whether it be a corporate organization, governmental organization, educational organization, etc., document management is important but very challenging for a myriad of reasons. To begin, in many organizations the sheer number of electronic documents is challenging. In many situations, organizations employ document management systems and related databases that may provide tools to organize documents. Various attributes of a document may be identified at the creation of the document. For example, a user may name the document, and store the document in a file structure that implicitly relates the document with other documents, which may be based on any number of relational and/or hierarchical characteristics including the type of document, a project, the creator of the document, etc. However, at creation, it is quite possible that none or few of these attributes may be associated with a document. Documents may also be categorized during a procurement phase that occurs after the initial document is created. Overall, whether at creation or during a later procurement, organizations often expend great resources reviewing and/or categorizing documents so that that those documents can be discovered in a search or otherwise identified at a later time based on information associated with each document.

In the majority of situations, however, document organization is a manual process. For example, many organizations manually associate, whether at creation, when uploaded into a system, or at some point later, attributes or metadata with each document that describe particular aspects of the stored electronic document. These manually applied attributes serve to aid end users in grouping and organizing information and identifying related documents. However, this process of manual attribution is often incomplete for a variety of reasons including a user having an incomplete understanding of the document necessary for proper definition, attribution tools being insufficient for proper and complete attribution, simple lack of prioritization, human error, and any number of other issues. In even a high functioning environment, a user may simply have insufficient knowledge about a document, or the information may simply not yet be knowable.

In addition and depending on the project, accessing the database to identify the correct documents for a particular search, let alone properly analyzing each document, can be burdensome due to the errors common in manual attribution of the documents. For example, in a complicated transaction, there may be many documents related to the transaction, and additional documents created over time. It would not be uncommon for a document or documents related to the transaction to be mis-labeled, stored incorrectly, simply not labeled, be correctly but insufficiently labeled, etc. Hence, when a user attempts to search for documents related to the transaction, not all documents are retrieved due to any one or more of the above issues or other issues. Further complicating document organization, each document may be organized uniquely and use different attribute terms, even when they pertain to the same topic, adding to the difficulty in properly aggregating the documents.

It is with these observations in mind, among others, that aspects of the present disclosure were concerned and developed.

### SUMMARY

Embodiments of the disclosure concern document management systems and methods. A first implementation includes a method for aggregating related documents comprising the operations of accessing, by a processor and based on receiving an attribute associated with aggregating related documents, a plurality of electronic documents and receiving, after receiving the attribute and by a trained machine learning model, a plurality of values each corresponding to one or more categories related to the content of a text of the plurality of electronic documents. The method may further include associating, by the processor, the received attribute with a subset of the plurality of electronic documents, wherein each of the subset of the plurality of electronic documents is associated with at least one of the plurality of values corresponding to the received attribute and generating, by the processor, a graphical user interface. The graphical user interface may include a first portion displaying a portion of each of the subset of the plurality of electronic documents and a second portion displaying one or more of the plurality of values common to the subset of the plurality of electronic documents.

Other implementations may include a system for aggregating related documents comprising a processor and a memory comprising instructions that, when executed, cause the processor to perform operations. Such operations may include accessing, based on receiving an attribute associated with aggregating related documents, a plurality of electronic documents, receiving, by a trained machine learning model and after receiving the attribute, a plurality of values each corresponding to one or more categories related to a content of a text of the plurality of electronic documents, and associating the received attribute with a subset of the plurality of electronic documents, wherein each of the subset of the plurality of electronic documents is associated with at least one of the plurality of values corresponding to the received attribute. The operations may also include generating a graphical user interface including a first portion displaying a portion of each of the subset of the plurality of electronic documents and a second portion displaying one or more of the plurality of values common to the subset of the plurality of electronic documents.

Yet another implementation may include one or more non-transitory computer-readable storage media storing computer-executable instructions for performing a computer process on a computing system. The computer process may include the operations of accessing, by the computing system and based on receiving an attribute associated with aggregating related documents, a plurality of electronic documents and receiving, after receiving the attribute and by a trained machine learning model, a plurality of values each corresponding to one or more categories related to the content of a text of the plurality of electronic documents. The method may further include associating, by the computing system, the received attribute with a subset of the plurality of electronic documents, wherein each of the subset of the plurality of electronic documents is associated with at least one of the plurality of values corresponding to the received attribute and generating, by the computing system, a graphical user interface. The graphical user interface may include a first portion displaying a portion of each of the subset of the plurality of electronic documents and a second portion displaying one or more of the plurality of values common to the subset of the plurality of electronic documents.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 is a system diagram for a document management system for relating and aggregating electronic documents, in accordance with various embodiments.

FIG. 2 is a flowchart of a method for aggregating electronic documents through a document management system, in accordance with various embodiments.

FIG. 3 is an example screenshot of a user interface for selecting key attributes for aggregating electronic documents, in accordance with various embodiments.

FIG. 4 is a flowchart of a method for identifying attributes of documents of a document management platform, in accordance with various embodiments.

FIG. 5 is an example screenshot of a user interface displaying aggregated documents associated with a key attribute, in accordance with various embodiments.

FIG. 6 is an example screenshot of a user interface displaying a particular document of a set of aggregated documents associated with a key attribute, in accordance with various embodiments.

FIG. 7 is a system diagram for ordering documents in a document management system for documents including amendments, such as contract documents, in accordance with various embodiments.

FIG. 8 is an example screenshot of a user interface displaying aggregated documents associated with a key attribute and an identified conflict between at least two documents, in accordance with various embodiments.

FIG. 9 is a flowchart of a method for identifying and correcting an identified conflict between documents in an aggregated set of documents, in accordance with various embodiments.

FIG. 10 is a system diagram of an example computing system that may implement various systems and methods discussed herein, in accordance with various embodiments.

### DETAILED DESCRIPTION

Aspects of the present disclosure involve systems and methods for automated analysis of documents to obtain attributes associated with those documents, and using the attributes to organize, relate, and/or aggregate documents. Attributes, or generally features of a document generated by the system, can be applied to the document or inferred from the document based on a machine learning model. One or more of either of these types of attributes can be used to relate documents together, join them together, or aggregate them with their associated metadata into a composite result. The aggregation of attributes may include rules for how attributes are to be aggregated.

In one implementation, a document management system may receive a collection of documents and, in some instances, scan the documents to create a corresponding image for use in aggregating the documents. Attributes, also referred to herein as “key values” or “key attributes”, for generating an aggregation of documents may be received at the document management system. In one instance, the key attributes may be received via a graphical user interface (also referred to herein as a “user interface”). An artificial intelligence or machine learning technique may then be applied to the collection of documents to extract or otherwise determine attributes or data from the documents. In an example in which the documents include a contract, such determined attributes may include names of parties to the contract, agreement numbers, expiration dates, initiation dates, particular provisions of the documents, auto-renewal indicators and the like. The artificial intelligence or machine learning techniques may also interpret portions of the electronic documents to infer one or more attributes of the documents. The received key attributes may be compared to these extracted or inferred attributes to determine if a match between the key attributes and the extracted or inferred attributes is present. Documents that have extracted or inferred attributes that match the provided key attributes may be included in an aggregation of related documents. Additional documents may also be included in the aggregation based on the extracted or inferred attributes. For example, an analysis of the attributes associated with the documents in the aggregation may generate a document profile for documents within the aggregation. Other documents managed by the document management system that do not include the provided key attributes but nonetheless include attributes common to the other documents in the aggregation may also be selected for inclusion in the library of related documents.

Using artificial intelligence data extractions and interpretations of document content to infer the presence of attributes in the documents brings at least two benefits: 1) allowing for the data attribution process to be automated (and only augmented by human intervention) thereby creating a higher degree of accuracy and completeness in the attribution process and 2) allowing for documents to be aggregated across many different types of attributes beyond those known a priori. Additionally, the aggregated documents may be displayed via a user interface in a manner as to indicate a current active “state” of a particular relationship, contractual obligation, or otherwise of the related documents. Displaying document attribute instances of key data across all of the participating documents in an aggregate may provide a clear understanding of what key data is to be considered in making a decision or interpretation on the aggregate of related documents.

In still another instance, the document management platform may provide for identification and/or correction of conflicts within an aggregate of related documents. For example, a particular provision of an aggregation of contract documents may be extracted from the documents and compared. Instances in which the compared portions from the aggregated documents do not match, a potential conflict between the documents may be displayed on a user interface. Conflict between any aspect of the aggregated documents may trigger a conflict alert on the user interface. Further, the conflict between the documents may be resolved by the document management platform by altering a document or altering an extracted portion of the document to match a controlling version of the portions in conflict. The controlling version of the portion in conflict may be selected by a user of the interface in one example. In another, the document management platform may select a controlling version of the portion based on other document information, such as execution date or document type, and correct the documents in the aggregated collection based on the selected controlling version.

Generally, the system may receive a document as an image file (e.g., PDF, JPG, PNG, etc.), and the system extracts text from the image file. In some embodiments, the system may receive one or more images of, for example, oil and gas documents. In some cases, the received image document may have been pre-processed to extract the text and thus includes the text level information. Text extraction can be done by various tools available on the market today falling within the broad stable of Optical Character Recognition (“OCR”) software. The extracted text may be associated or otherwise linked with the particular location in the document from which it was found or extracted.

Extracted text may then be fed into a trained machine learning model. The trained machine learning model may be trained on sample data and/or previously received documents so that it can identify categories and subcategories, which it associates with particular sections of text. Thus, even if a document does not include particular section titles, spacing key-words or other identifiers, extracted text may still be associated with an appropriate category. Having identified categories, which may further include subcategories, associated with particular sections of the text, the particular locations associated with the particular sections of text can then also be associated with the identified categories and subcategories as well. These categories and subcategories may then be used to build an aggregated collection of related documents based on one or more key attributes of the stored documents.

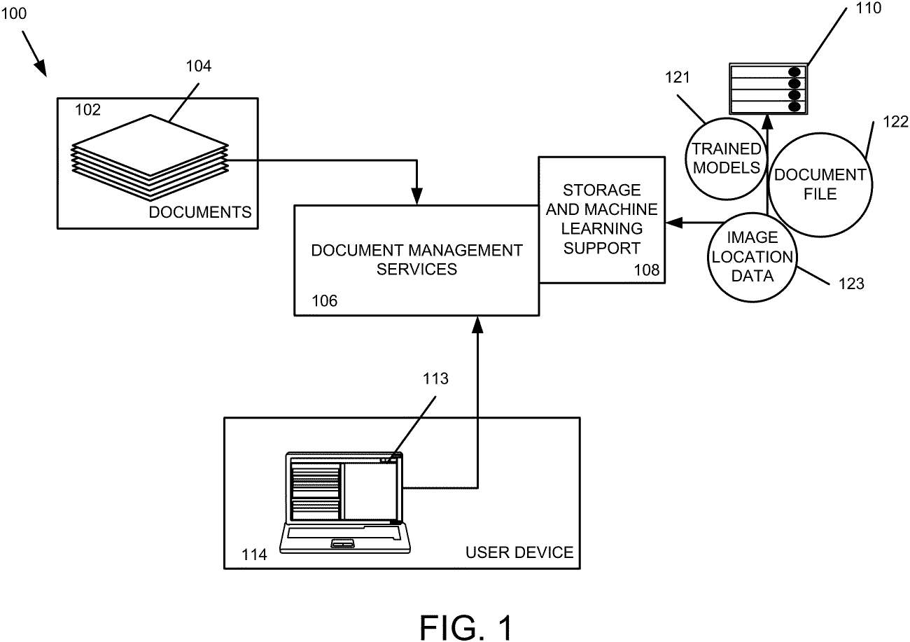

FIG. 1 depicts one example a document management system for relating and aggregating electronic documents. The system 100 receives or otherwise accesses one or more electronic documents 102 through a file system, a database, and the like. The system described herein may be used with any type of document. However, for purposes of illustrating various aspects of the present disclosure, the electronic document 102 is a legal document, such as a contract between two or more parties.

In the example illustrated, an image 122 of the electronic document is stored in a system database or other memory provided by a document management platform 106. It should be recognized that the document, when first loaded to or accessed by the system, may be in the form of image. It is often the case, for example, that final documents of some form of transaction are in image form, e.g., a PDF file or the like. The system, however, may work natively with other electronic forms of documents, such as those generated from word processing programs. The database can be a relational or non-relational database, and it will be apparent to a person having ordinary skill in the art which type of database to use or whether to use a mix of the two. In some other embodiments, the document may be stored in a short-term memory rather than a database or be otherwise stored in some other form of memory structure. Documents stored in the system database may be used later for training new machine learning models and/or continued training of existing machine learning models through utilities provided by the document management services platform 106. The document management services platform 106 can be a cloud platform, locally hosted, locally hosted in a distributed enterprise environment, distributed, combinations of the same, and otherwise available in different forms.

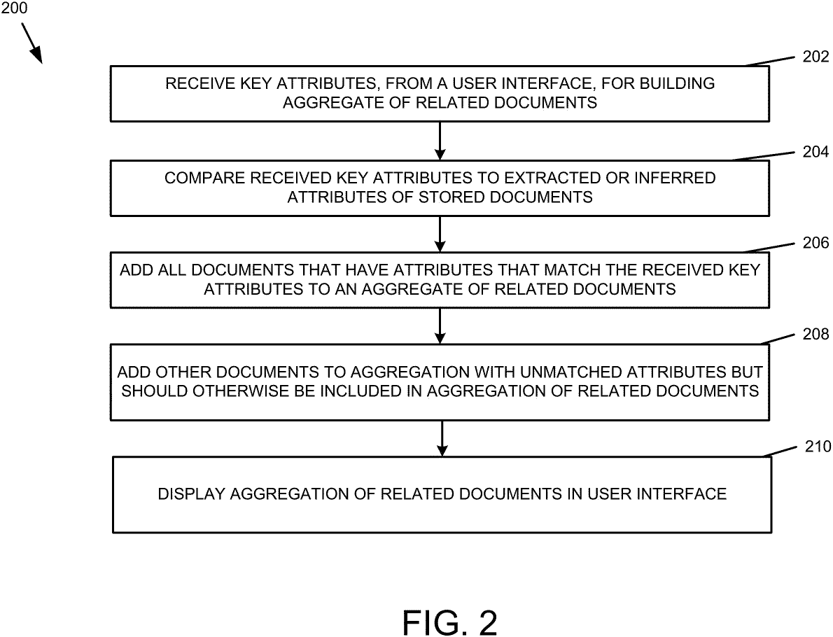

The document management services platform 106 may provide systems and methods for relating and aggregating the stored electronic documents 102. In particular, the document management services platform 106 may aggregate one of more of the documents 102 based on one or more key attributes identified through a user interface 113 executed on a user device 114. FIG. 2 is a flowchart of a method 200 for aggregating electronic documents 102 through a document management system or platform 106. The operations may be executed by the document services platform 106, the computing device on which the user interface 113 is executed, or a combination of both. Through the method 200, an aggregation of related documents may be identified and displayed on the user interface 113.

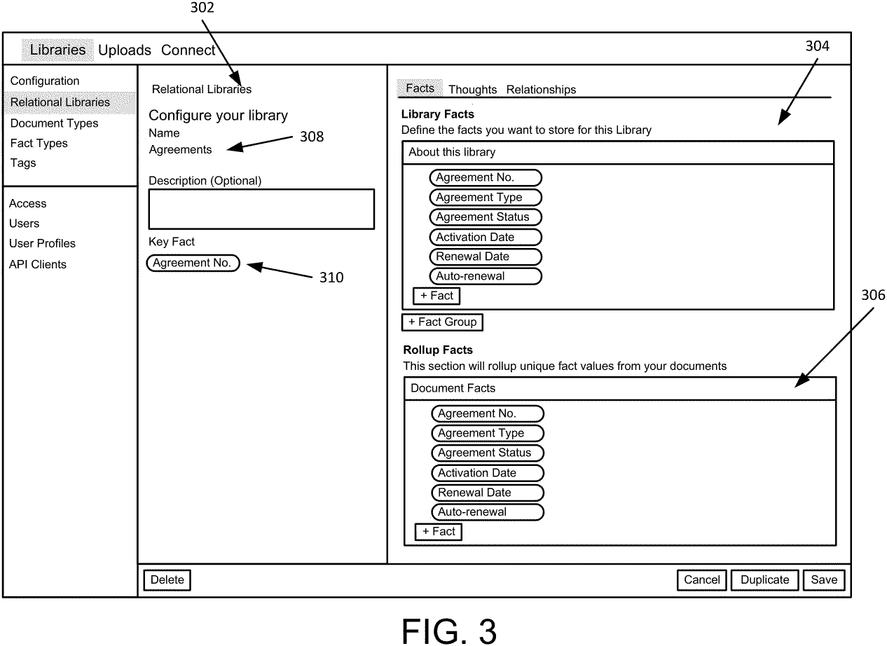

Beginning in operation 202, the document management platform 106 may receive one or more key attributes for building an aggregate of related documents. In one instance, the attributes may be received via the user interface 113. One particular example of a user interface for defining key attributes for aggregating related documents is illustrated in FIG. 3. The user interface 300 may be displayed on the user computing device 114 and receive inputs from any number and type of input devices, such as a keyboard, mouse, touchscreen, etc. A user may navigate the user interface to the displayed interface page 300 through any number of selections and inputs. From the interface 300, a user may define key attributes by way of selecting from a list of particular attributes - referred to as “facts” in the illustrated user interface - that may be utilized by the document management system 106 to aggregate related documents. In the example shown, a first portion 302 of the interface 300 may include an area 308 for providing a name to a particular aggregation, or “library”, of documents, such as a general term like “Agreements” or more specific terms that would more narrowly identify documents within a given library. In general, the library name may be any combination of alphanumeric characters that may be used to differentiate one library from another. Also within the first portion 302 of the interface 300, a user may select or otherwise identify the key attributes 310 that the document services platform 106 utilizes to generate the library by identifying documents that include the key attribute or are inferred to include or relate to the key attribute. In the example shown in FIG. 3, the selected key attribute for the aggregation of related documents is “Agreement No.”. The “Agreement No.” key attribute indicates that documents of the document management platform 106 are aggregated based on the same or similar agreement number extracted or inferred from the documents stored in the document management platform 106 that correspond to a provided specific Agreement No. key attribute value. For example, the key attribute may be selected and a specific agreement number of “111-111” may be provided as a value of the key attribute. Documents including or otherwise associated with the provided key attribute value may then be identified and aggregated as discussed herein. In general, the key attribute may be any extractable or inferred portion or data of a document, such as a company or party name, a date, a project identifier, and in the case of legal documents related to oil and gas transactions information such as an oil well identifier, a pipeline identifier, etc. Further, the aggregation of related documents may be based on more than one key attribute. In one implementation, a user, by way of the user interface 300, may include multiple key attributes in the first portion of the user interface for use in aggregating related documents in the document management platform 106. For example, a second key attribute, such as “Company Name”, may be included in the first portion 302 of the user interface 300 to aggregate documents that share the same or similar Agreement No. and Company Name. The user interface 300 may therefore be utilized to select key attributes for building a document aggregation.

Returning to FIG. 2, the document management platform 106 may, in operation 204, compare the received key attributes or facts to attributes of the stored documents of the platform database. Unlike a conventional word search that matches a key attribute to preexisting word or words within a document, the document attributes associated with the documents may be extracted through one or more artificial intelligence or machine learning techniques of the platform 106 and/or interpret portions of the document content to infer the document attributes. Some particular techniques for extracting data from the documents to generate the document attribute values of the documents are described in U.S. Pat. Application No. 15/887,689, entitled NATURAL LANGUAGE PROCESSING SYSTEM AND METHOD FOR DOCUMENTS, the entirety of which is incorporated by reference herein.

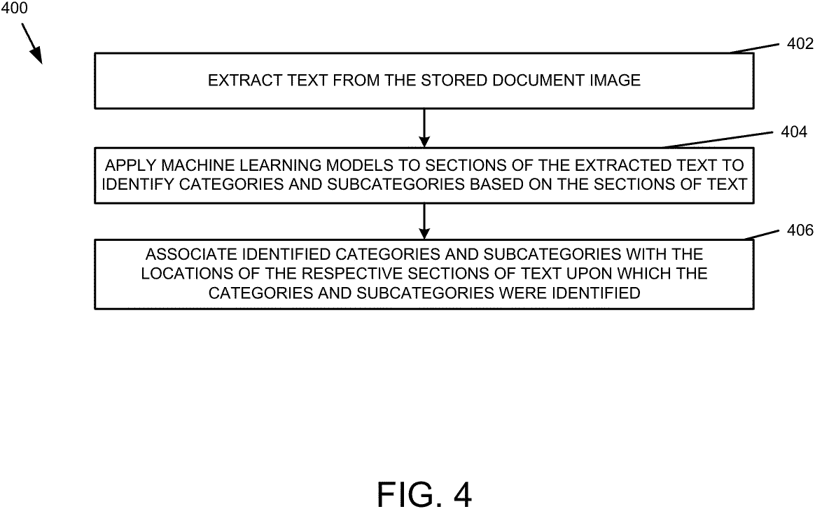

A general description of the techniques for extracting attributes from the documents or otherwise inferring the document attributes is illustrated in the method 400 of FIG. 4. As introduced above, the document management platform 106 may utilize machine learning techniques for identifying and/or extracting document attributes. In one example, the system operates on text of a document. In some cases, the document will include searchable text. In other cases, such as when only an image is available, the document management system 106 may extract text from the documents 102 of the document management platform 106, in operation 402. The text may be extracted, in one example, from the document by way of Optical Character Recognition (“OCR”) technology. In one implementation, a storage and machine learning support 108 subsystem may process document images using OCR and associate the extracted text with the respective document image. In some instances, the system may further associate a location in the document from where specific text was extracted. The locations of the extracted text can be saved to the remote device 110 as document location data 123 specifically tied to the relevant document 122.

Machine learning models may be applied to the text to identify categories and subcategories for the text in operation 404. In one specific example system implementation, machine learning services utilize the storage and machine learning support 108 to retrieve trained models 121 from a remote device 110, which may include a database or other data storage facility such as a cloud storage service. The machine learning models 121 may identify categories and subcategories based on learned ontologies which are taught to the models through training on batches of text from previous documents received by the system and from training data, which may be acquired during the initial deployment of the system or otherwise. A learned ontology can allow a machine learning model 121 to identify a category or subcategory based on relationships between words, key words, and other factors determined by the machine learning algorithm employed, and will identify concepts and information embedded in the syntax and semantics of text. For example, in some oil and gas lease agreements, there is a specific legal concept referred to as a lot description. Thus, where a simple key word search of extracted text may not be capable alone of identifying a key word of “lot description” unless the exact term is present, machine learning can be used to analyze the document, including but not limited to the extracted text, and identify the “lot description” based on other criteria besides the use of the exact term such as using a previously identified location of the lot (e.g., via the lot state, lessor state, applicable laws state, etc.) to identify probable formats for the lot description and/or other qualities of the text (e.g., proximate categories, such as lessor name or related categories, such as state, and the like). In another example, a legal concept typical in various oil and gas industry documents is a “shut-in” provision. However, it is often the case that there is not a specific provision heading explicitly titled “shut-in” and in many instances the specific term “shut-in” is not used in what would otherwise be considered a shut-in provision as the document section is describing a shut-in provision but without explicitly using the term “shut-in.” Thus, the machine learning models may process the extracted words, along with other document attributes, to identify if a portion of the extracted text is a “shut-in” provision based on the use words typical of shut-in (e.g., “gas not being sold”), the use of sets of similar words being used in proximate locations (e.g., “gas not being sold,” “capable of producing,” and “will pay”) to identify a category. Such named entity resolution techniques may be applied to any identified text in a document. The machine learning algorithm employed may be a neural network, a deep neural network, support vector machines, a Bayesian network or networks, a combination of multiple algorithms, or any other implementation that will be apparent to a person having ordinary skill in the art.

In operation 406, the extracted text and automated category and/or subcategory identifications may be associated with locations in the respective document pertaining to the text of such categorizations. The category, subcategory, and location information may be stored in the document management platform 106 or remote devices 110 for use in matching to one or more key attributes for aggregated related documents. In some instances, the extracted text may be a hash value of a portion of a document. For example, a particular clause of a contract or other section of words or paragraph of a document may be transformed into a hash value for comparison to a key attribute. In this example, the document management platform 106 may similarly determine a hash value for a key attribute, such as a provision of a document, for comparison to the hash value of the document attribute. In one particular implementation, the method 400 of FIG. 4 may be executed on the documents in the document management platform 106 after receiving the key attributes for a library or aggregation from the user interface 300.

The categories and/or subcategories of the text of the stored documents may be used to aggregate related documents. For example, a portion of a document may be identified as a “Company Name” category or subcategory and an extracted document attribute may be associated with the document as a “Company Name” value. Similarly, an agreement number, such as 123456, may be identified in the document as an agreement number and associated with an “Agreement No.” category or subcategory. To aggregate documents, the document management platform 106 may utilize the categorization of the extracted or inferred attributes associated with the documents to identify documents to include in the aggregation. For example, a “Company Name” key attribute may be identified for aggregation and, in response, the document management platform 106 may identify portions of stored documents categorized as a company name for comparison to a received company name value and determine if the document is to be included in the aggregation of documents. In this manner, categories or subcategories of portions of the stored electronic documents may be identified through the machine learning or artificial intelligence techniques and such categories may be used to aggregate documents as corresponding to a received key attribute.

Returning to FIG. 2, the document management platform 106 may, in operation 206, add one or more of the stored documents 102 (or a subset of all of the stored documents) to an aggregation of related documents, or library, based on the comparison of a key attribute or attributes to the document attributes. If the selected or indicated key attribute matches a document attribute, that document may be included in the aggregation. For example, a particular agreement number, such as 111-111, may be indicated through the user interface as a key attribute for building an aggregation of library of related documents. Upon receiving the agreement number, the document management platform 106 may extract data from the documents stored with the platform through a machine learning or artificial intelligence technique as explained above. One or more of the documents may include an agreement number appearing within the documents that may therefore be extracted or identified within the documents. Through a comparison of the indicated agreement number to the determined or found document attributes, those documents that include the indicated agreement number may be identified and collected or aggregated into a library of related documents. In this manner, all of the documents that relate to the provided key attribute may be discovered and displayed. In the instances in which multiple key attributes are provided, the document management platform 106 may aggregate all the documents that include one of the multiple key attributes, some of the key attributes, or all of the key attributes.

Aggregation of documents may be based on any data obtainable or inferred from the document. For example, related documents associated with a vendor name may be aggregated based on a key attribute identifying that vendor name. Also, as described above, aggregation may occur on entire clauses of the documents. For example, a user may provide a termination clause of a contract as a key attribute through the user interface. In one example, the document management platform 106 may generate a repeatable hash value based on the provided termination clause. Other techniques for converting a clause into a searchable form may also be utilized to compare a provided clause to clauses of other documents, including but not limited to frequency-inverse document frequency (tf-idf) technique or a trained machine learning based embedding model technique. The platform 106 may also extract similar termination clauses from one or more documents stored with the platform and generate a hash value or other searchable value for the extracted clauses or paragraphs using the same techniques. A comparison of the provided clause hash value to the extracted clause hash values may determine if other documents in the stored documents 102 include the same or a similar termination clause. In this manner, an aggregation of documents may be generated based on an entire clause of a document.

In some instances, documents with extracted or inferred document attributes that do not match the provided key attribute may also be included in the aggregation of related documents in operation 208. For example, the document management platform 106 may determine that a document does not include the provided key attribute as a document attribute. However, several other document attributes may match document attributes for other documents included in the aggregation, such as vendor name, vendor address, site address, date of execution, date of expiration, etc. A correlation of document attributes for the aggregated collection of documents may yield some document attributes that are common to some or all of the documents. The document management platform 106 may then use these common attributes to identify other documents that may be related to the key attribute while not specifically including the key attribute itself. This technique may also be used to gather documents with errors into an aggregation. For example, a document may include an incorrect agreement number but should otherwise be included in an aggregation of related documents as belonging to a particular agreement. Through an analysis of the documents already included in the library, the document management platform 106 may identify a vendor name and expiration date that are common to all or most of the aggregated documents. Other documents stored with the platform 106 may also include the same vendor name and expiration date, but not include the agreement number key attribute. These other documents may also be included in the aggregation as possible related documents by the document management platform.

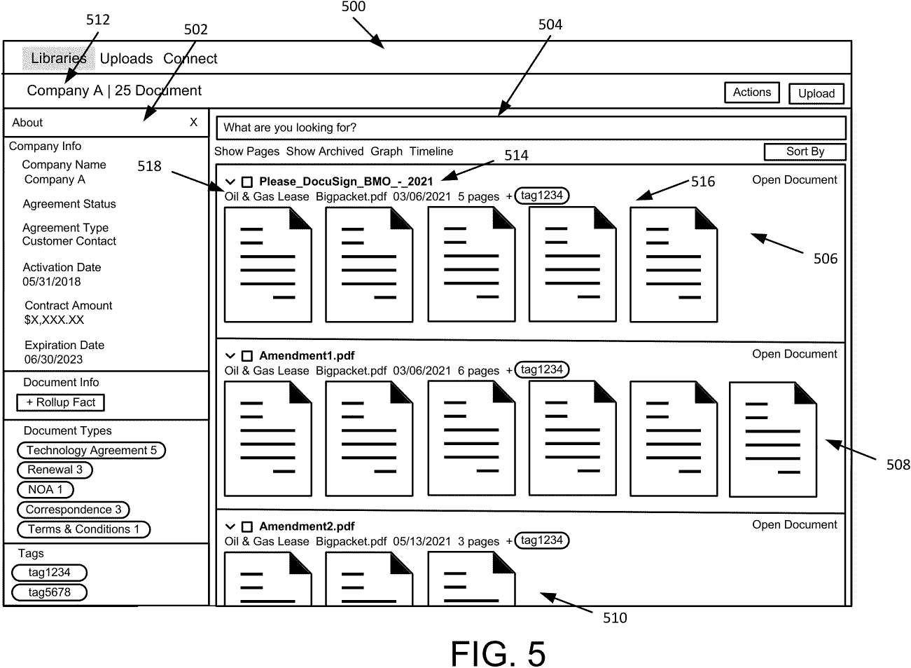

In operation 210, the aggregated documents based on the key attributes may be presented or otherwise displayed by the user device 114 on the user interface 113. FIG. 5 is an example screenshot of a user interface 500 displaying aggregated documents associated with a key attribute. In this example, the aggregation of related documents is based on a key attribute of a company name, particularly “Company A”. Thus, the document management platform 106 may have received the key attribute of “Company A” and a specific company name value and, through the process described above, aggregated related documents based on those documents for which the Company A key attribute is associated. The user interface 500 includes a first portion 502 that displays information associated with the aggregation of the related documents. A second portion 504 may also be included in the user interface 500 that displays some aspect of the aggregated documents. In particular, the second portion 504 may display a document title 514, information 518 about the illustrated document (such as document type, number of pages in the document, etc.), and a thumbnail image 516 of each page of the illustrated document. The example of FIG. 5 illustrates three documents in the aggregation (document A 506, document B 508, and document C), although any number of documents may be displayed in the second portion 504 of the user interface 500.

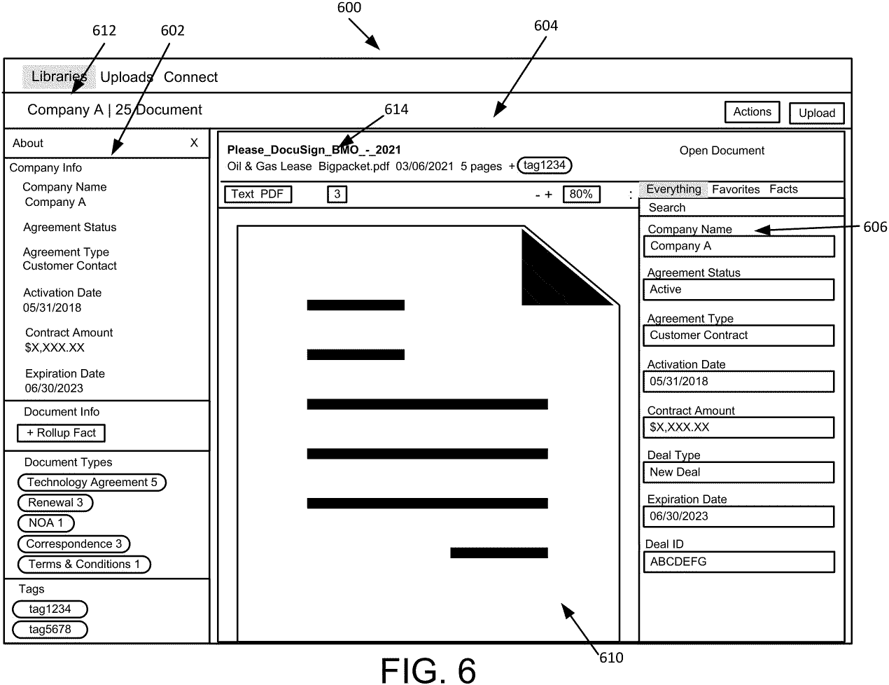

Each of the documents illustrated in the user interface 500 may be selectable through an input device to the user interface for display of the document. For example, selection of a thumbnail of a page of Document A 506 may expand the thumbnail to show the full page within the user interface. An expanded page of a document of the aggregated collection of related documents is illustrated in the user interface 600 of FIG. 6. Some aspects of the user interface 600 of FIG. 6 are the same or similar as the user interface 500 of FIG. 5. For example, the user interface 600 may include a first portion 602 that provides information associated with the aggregation of documents, such as a name of a company the subject of the aggregated documents, an agreement type, an expiration date of the agreement, and the like. An identification of the key attribute 612 used to aggregate the documents may also be displayed. The first portion 602 may not be altered from the user interface 500 of FIG. 5 through the selection of a thumbnail of the displayed document. Rather, a second portion 604 of the user interface 600 may be altered to display the selected document in more detail.

The second portion 604 of the user interface 600 may include an image 610 of the selected document or document page. For example, the image 610 may be a scan of a received document or a page or other portion of an electronic document. The second portion 604 may include a title or name 614 of the displayed document for reference by a user of the interface, along with other information, such as a type of document, the number of pages in the document, and the like.

A third portion 606 of the user interface 600 may display document attributes or other data or attributes extracted or inferred from the selected document. For example, the third portion 606 may include a company name, such as Company A, extracted from an analysis of the document. The document may be included in the aggregation of documents because this document attribute matches the key attribute 612 used to build the library. Other document attributes or information associated with the document are also noted in the third portion 606, such as a state of the agreement, an agreement type, an activation date, a deal type, etc. The information included in the third portion 606 may be obtained from the machine learning and artificial intelligence analysis of the documents to build ontologies of the document information to determine the various information contained in the document.

In a similar manner and returning to the user interface 500 of FIG. 5, the first portion 502 of the user interface 500 may include selected attributes or information associated with the aggregation of related documents. Such information may be obtained through the machine learning and artificial intelligence techniques discussed above to analyze the documents to build ontologies of the document information. In addition, the attributes or information obtained and stored for a library may be customizable via the user interface. In particular and returning to the user interface 300, the user interface 300 may include a portion 304 through which a user or computer may identify the attributes (labeled as “facts” in the illustrated user interface) about the library of aggregated documents is to be stored. For example, a user may select to store an agreement number attribute, an agreement type attribute, an agreement status attribute, an auto-renewal indicator, and the like for a given library of aggregated documents which may, in turn, be displayed in the user interface 500 of FIG. 5. In general, any number of attributes may be selected and configured for a given library. In a similar manner, any number of document attributes may be selected for rolling up through portion 306 of the user interface 300. These attributes may be obtained or determined from each of the documents of the library and stored for each of the corresponding document for display in user interface 600. In another example, a machine learning technique may be applied to a document or documents to automatically assert or infer attributes about the document or documents. For example, an agreement status attribute for a library of documents may be automatically inferred or asserted as “active” if a machine learning model infers that the expiration date for the library of related documents is greater than a current date. Other attributes of the library may also be determined and/or set through a machine learning technique in a similar manner.

Through the systems and methods described above, extracted or inferred attributes of electronic documents may be utilized to relate or aggregate documents. A current or active state of the aggregation of documents may be automatically provided without a manual attribution of data to the documents. Rather, artificial intelligence or machine learning techniques may be executed to extract and/or interpret the content of the documents to infer the document attributes. This process allows for a higher degree of accuracy and completeness of the aggregation process across many different types of documents. Such a system may also be utilized to identify potential conflicts of text or information within aggregated documents and provide a mechanism through which such conflicts may be corrected. One particular implementation for identifying and correcting potential conflicts within the documents of the aggregated library is described below.

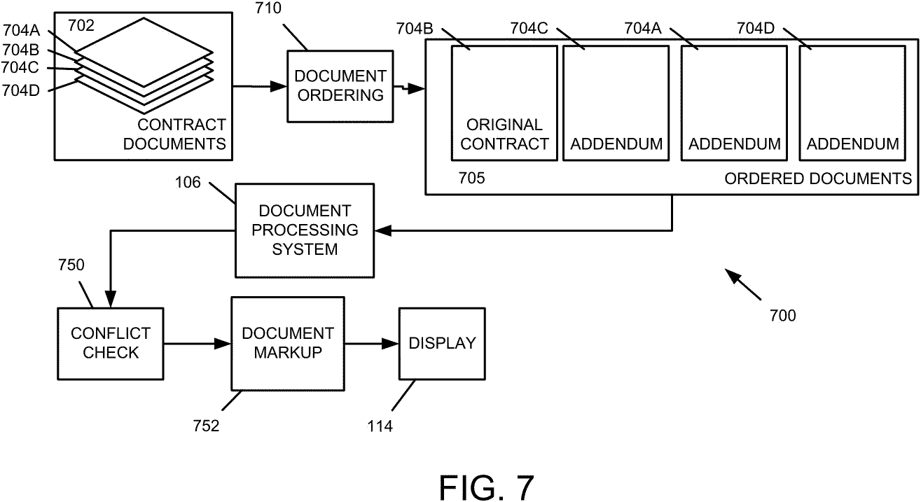

Referring now to FIG. 7, a conflict check system 750 and a document ordering system 710 may be included with the document management platform 106 for ordering and/or correcting determined errors or conflicts within the aggregated library of documents. In particular, the document ordering system 710 may receive an aggregated collection of documents and, in addition to the aggregation of the documents, may order the documents from an original document through one or more amending documents. In particular, a collection 702 of documents 704A-D may be received by an ordering system 710. Documents 704A-D may be received in any order and the ordering system 710 will sort and order them into a chronological order. In some embodiments, a rule-based sorting may be employed whereby ordering system 710 recognizes key words or characters associated with timing such as, for example, “Oct. 23, 2017” or “Oct. 23, 2017” and organize the documents according to the recognized key words or characters. In some embodiments, the ordering may be based on machine learning models trained to recognize a time component embedded, semantically or otherwise, into the text of the document.

The ordering system 710 may output a chronologically ordered set of documents 705. The ordered documents 705 may be organized differently than they are first received. For example, the original contract 704B may be sorted to the front of the received documents (thus denoting an earlier date), even though it was received after addendum 740A. As can be seen, the received documents are organized such that original contract 704B precedes addendum 704C, which precedes addendum 704A, which precedes addendum 704D. The document processing system 106, discussed above, can then receive the ordered documents in their correct sequence. However, where in some embodiments document processing system 106 may perform the document ordering as described herein.

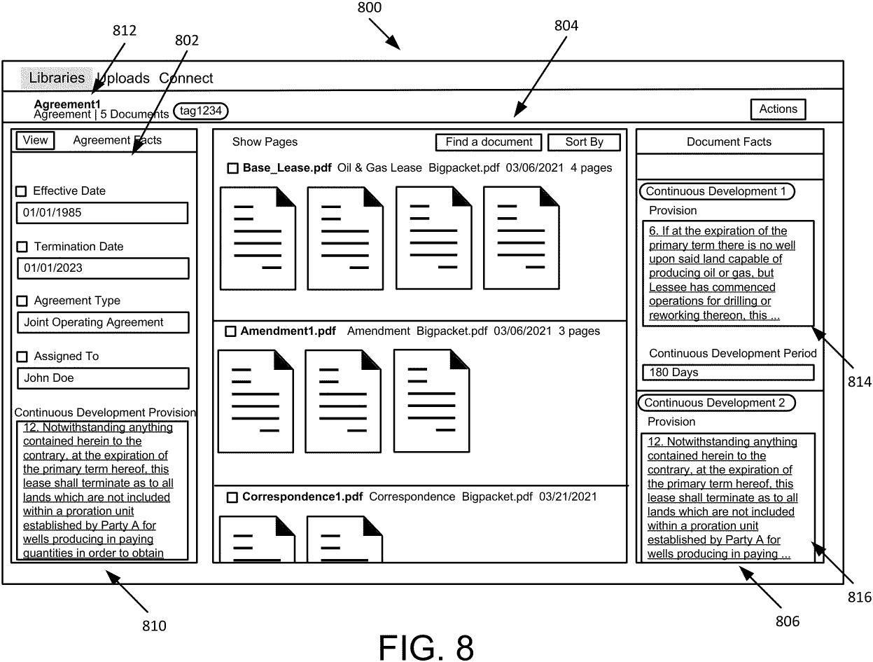

In addition to the document ordering system 710, the document management system 106 or another system may detect conflicts and, in some instances, rectify detected conflicts in the aggregated collection of related documents. A user interface for displaying aggregated documents associated with a key attribute and an identified conflict between at least two documents is illustrated in FIG. 8. As above, the user interface 800 may include a first portion 802 providing information associated with an aggregation of related documents. A key attribute 812 used to aggregate the documents may also be displayed in the user interface 800. In the example shown, the documents presented in second portion 804 are aggregated based on an agreement number key attribute, such as 111-111. A thumbnail of some of the aggregated documents is illustrated in portion 804, as above. In this example, however, a third portion 806 is displayed illustrating a potential conflict between two or more of the documents in the aggregation. In this particular example, a continuous development provision 810 is selected as an attribute for the aggregation of documents. However, the document management system 106 or other conflict identifying system may compare the continuous development provisions of the aggregated documents to determine if a difference or conflict between the documents exists. In one instance, a conflict is determined if the text of related provisions from two or more of the aggregated documents are different. For example, the continuous development provision 814 from a first document of the aggregated library of documents is different than the continuous development provision 816 from a second document of the aggregated library. Other techniques for comparing one clause to another clause of the aggregated documents may include, but is not limited to, a frequency-inverse document frequency (tf-idf) technique or a trained machine learning based embedding model technique. This conflict check of different text of attributes of the aggregated documents may be conducted for any attribute or data of the documents. For example, the documents may be checked to ensure that a termination date of the deal, an effective date, and/or an agreement type is the same throughout all of the documents, among any other type of fact or data of the documents. In this manner, potential mistakes or errors within the documents that may cause a conflict between documents may be identified and presented through the user interface 800.

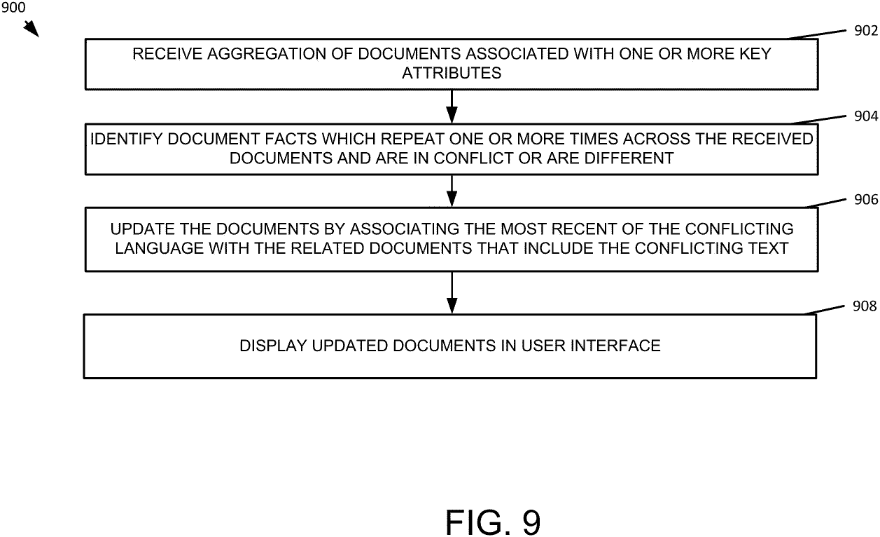

Returning to FIG. 7, a conflict check system 750 may perform the method 900 illustrated in FIG. 9 to identify conflicts and provide potential resolutions to detected conflicts. In some embodiments, the conflict check module 750 may be of the document processing system 106 or may be separate. Regardless, the conflict system 750 may receive a collection of documents associated with an aggregation of related documents in operation 902. One or more document attributes that repeat one or more times across the received documents and have conflicting or different values may be identified in operation 904. For example, a continuous development provision of a contract agreement may be identified as included in two or more documents of the aggregated documents. Further, the continuous development provisions may be identified as differing in some manner, such as using different language, party identifiers, termination dates, and the like. As shown in the user interface 800 of FIG. 8, the conflicting document information or text may be displayed to a user for correction. A user of the interface 800 may, in some instances, select one of the presented text as the controlling provision or text for the entire library of documents or agreement. The document management platform 106 may, in response to the selection of a controlling provision or correct text, update the documents within the library with the selected provision or text such that all of the documents agree and a conflict no longer exists among the documents.

In another instance, the document management platform 106 or other system may update the aggregated documents automatically. For example, the conflict check system 750 may provide the documents to a document markup system 752 for correction. The document markup system 752 may update one or more of the documents based on an ordering of the documents as determined by the document ordering system 710. In general, the document markup system 752 may determine the provision or text that is most recent in the ordered documents 705 and update the remaining documents with the most recent text or provision in operation 906. In another example, the document markup system 752 may determine the most often used provision or text for a document feature and select that version of the conflicting text for updating the documents in the aggregation. Regardless of the technique used by the system to select a controlling version of the conflicting information, one or more of the documents of the aggregated collection of documents may be corrected with the controlling version. The corrected documents may be displayed in the user interface in a manner similar to above in operation 908.

The document management system 106 described herein may include many such automated techniques and features. For example, the document management system 106 may incorporate a rule base that requires a certain number of documents to be within an aggregate of documents to limit the number of documents or for expanding the number of documents which may apply to the key attribute defining the aggregate. A similar rule for a certain type of documents may also be applied by the document management platform 106. In another example, the document management platform may include a rule set that defines relationships and hierarchy between types of documents (i.e., amendments supersede contracts) when determining a state of the aggregated documents. In another rule, a requirement that any defined aggregate of documents must include certain types of attributes and/or a certain number or type of each of the required attributes. Through these various rule sets, configurations or parameters of the aggregated collection of documents may be established and enforced by the document management platform 106.

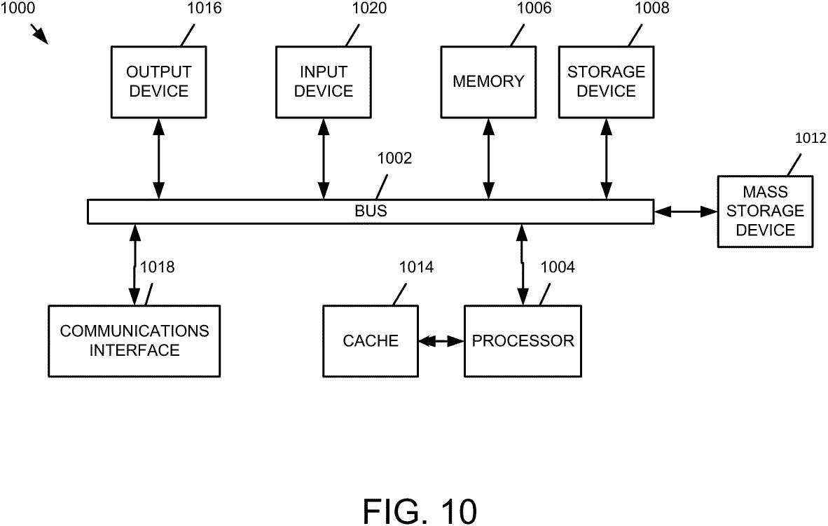

FIG. 10 an example computing system 1000 that may implement various systems and methods discussed herein. The computer system 1000 includes one or more computing components in communication via a bus 1002. In one implementation, the computing system 1000 includes one or more processors 1004. The processor 1004 can include one or more internal levels of cache (not depicted) and a bus controller or bus interface unit to direct interaction with the bus 1002. Main memory 1006 may include one or more memory cards and a control circuit (not depicted), or other forms of removable memory, and may store various software applications including computer executable instructions, that when run on the processor 1004, implement the methods and systems set out herein. Other forms of memory, such as a storage device 1008 and a mass storage device 1012, may also be included and accessible, by the processor (or processors) 1004 via the bus 1002. The storage device 1008 and mass storage device 1012 can each contain any or all of an electronic document.

The computer system 1000 can further include a communications interface 1018 by way of which the computer system 1000 can connect to networks and receive data useful in executing the methods and system set out herein as well as transmitting information to other devices. The computer system 1000 can include an output device 1016 by which information is displayed, such as the display 300. The computer system 1000 can also include an input device 1020 by which information is input. Input device 1020 can be a scanner, keyboard, and/or other input devices as will be apparent to a person of ordinary skill in the art. The system set forth in FIG. 10 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the methods can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a computer-readable storage medium having stored thereon instructions, which may be used to program a computer system (or other electronic devices) to perform a process according to the present disclosure. A computer-readable storage medium includes any mechanism for storing information in a form (e.g., software, processing application) readable by a computer. The computer-readable storage medium may include, but is not limited to, optical storage medium (e.g., CD-ROM), magneto-optical storage medium, read only memory (ROM), random access memory (RAM), erasable programmable memory (e.g., EPROM and EEPROM), flash memory, or other types of medium suitable for storing electronic instructions.

The description above includes example systems, methods, techniques, instruction sequences, and/or computer program products that embody techniques of the present disclosure. However, it is understood that the described disclosure may be practiced without these specific details.

While the present disclosure has been described with references to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for aggregating related documents, the method comprising:
accessing, by a processor and based on receiving an attribute associated with aggregating related documents, a plurality of electronic documents;
receiving, after receiving the attribute and by a trained machine learning model, a plurality of values each corresponding to one or more categories related to a content of a text or an associated metadata of the plurality of electronic documents;
associating, by the processor, the received attribute with a subset of the plurality of electronic documents, wherein each of the subset of the plurality of electronic documents is associated with at least one of the plurality of values corresponding to the received attribute; and
generating, by the processor, a graphical user interface including:
a first portion displaying a portion of each of the subset of the plurality of electronic documents; and
a second portion displaying one or more of the plurality of values common to the subset of the plurality of electronic documents.

2. The method of claim 1 wherein the attribute is selected from one of a company name, an agreement number, an agreement type, an agreement status, an expiration date, an activation date, or an auto-renewal status.

3. The method of claim 1 wherein the graphical user interface further includes a third portion displaying the plurality of values associated with a selected one electronic document of the subset of the plurality of electronic documents.

4. The method of claim 1, further comprising:
adding a second subset of the plurality of electronic documents to the subset of the plurality of electronic documents based on the second subset of the plurality of electronic documents being associated with the one or more of the plurality of values common to the subset of the plurality of electronic documents.

5. The method of claim 1 wherein displaying the one or more of the plurality of values common to the subset of the plurality of electronic documents is based on a selection of the one or more of the plurality of values via the graphical user interface.

6. The method of claim 1 wherein the received attribute is a paragraph, the method further comprising:
converting, by the processor and via a hashing technique, the paragraph to a hashed value, the at least one of the plurality of values comprising the hashed value.

7. The method of claim 1 wherein a first of the plurality of values of a first electronic document conflicts with a second of the plurality of values of a second electronic document, the graphical user interface further including an indication of the conflict between the first electronic document and the second electronic document.

8. The method of claim 7, the method further comprising:
selecting a controlling version for the conflict between the first electronic document and the second electronic document; and
editing at least one of the subset of the plurality of electronic documents to include the controlling version.

9. The method of claim 1 wherein the electronic document is received as an image file and converted to a text format using optical character recognition software.

10. A system for aggregating related documents, the system comprising:
a processor; and
a memory comprising instructions that, when executed, cause the processor to:
access, based on receiving an attribute associated with aggregating related documents, a plurality of electronic documents;
receive, by a trained machine learning model and after receiving the attribute, a plurality of values each corresponding to one or more categories related to a content of a text of the plurality of electronic documents;
associate the received attribute with a subset of the plurality of electronic documents, wherein each of the subset of the plurality of electronic documents is associated with at least one of the plurality of values corresponding to the received attribute; and
generate a graphical user interface including:
a first portion displaying a portion of each of the subset of the plurality of electronic documents; and
a second portion displaying one or more of the plurality of values common to the subset of the plurality of electronic documents.

11. The system of claim 10 wherein the attribute is one of a company name, an agreement number, an agreement type, an agreement status, an expiration date, an activation date, or an auto-renewal status.

12. The system of claim 10 wherein the graphical user interface further includes a third portion displaying the plurality of values associated with a selected one electronic document of the subset of the plurality of electronic documents.

13. The system of claim 10 wherein the instructions, when executed, further cause the processor to:
add a second subset of the plurality of electronic documents to the subset of the plurality of electronic documents based on the second subset of the plurality of electronic documents being associated with the one or more of the plurality of values common to the subset of the plurality of electronic documents.

14. The system of claim 10 wherein displaying the one or more of the plurality of values common to the subset of the plurality of electronic documents is based on a selection of the one or more of the plurality of values via the graphical user interface.

15. The system of claim 10 wherein the received attribute is a paragraph, the instructions, when executed, further causing the processor to:
convert, by the processor and via a hashing technique, the paragraph to a hashed value, the at least one of the plurality of values comprising the hashed value.

16. The system of claim 10 wherein a first of the plurality of values of a first electronic document conflicts with a second of the plurality of values of a second electronic document, the graphical user interface further including an indication of the conflict between the first electronic document and the second electronic document.

17. The system of claim 16, wherein the instructions, when executed, further cause the processor to:
select a controlling version for the conflict between the first electronic document and the second electronic document; and
edit at least one of the subset of the plurality of electronic documents to include the controlling version.

18. The system of claim 10 wherein the electronic document is received as an image file and converted to a text format using optical character recognition software.

19. One or more non-transitory computer-readable storage media storing computer-executable instructions for performing a computer process on a computing system, the computer process comprising:
accessing, by the computing system and based on receiving an attribute associated with aggregating related documents, a plurality of electronic documents;
receiving, after receiving the attribute and by a trained machine learning model, a plurality of values each corresponding to one or more categories related to a content of a text or an associated metadata of the plurality of electronic documents;
associating, by the computing system, the received attribute with a subset of the plurality of electronic documents, wherein each of the subset of the plurality of electronic documents is associated with at least one of the plurality of values corresponding to the received attribute; and
generating, by the computing system, a graphical user interface including:
a first portion displaying a portion of each of the subset of the plurality of electronic documents; and
a second portion displaying one or more of the plurality of values common to the subset of the plurality of electronic documents.

20. The computer-readable storage media of claim 19 wherein the attribute is selected from one of a company name, an agreement number, an agreement type, an agreement status, an expiration date, an activation date, or an auto-renewal status.
